(19) United States
(12) Patent Application Publication
(10) Pub. No.: US 2007/0009645 A1
(43) Pub. Date: Jan. 11, 2007

(54) Eggspooner

(76) Inventor: Botho Karl Michael Holzer, Neuss (DE)

Correspondence Address: Botho Holzer, Alexianerplatz 1, 41464 Neuss, DE

(21) Appl. No.: 11/409,916

(22) Filed: Apr. 25, 2006

(30) Foreign Application Priority Data
Jul. 5, 2005 (DE) 20 2005 010 509.0

(51) Int. Cl. A23L 1/32

(52) U.S. Cl. 426/614

(57) ABSTRACT

Artificial lockable egg-cooking shell and so a cooking appliance for eggs and several ingredients, consisting of a receptacle and a screw cap. The screw cap has got a by a layer of PTFE isolated sealing compound at its inside to protect the ingredients against contamination.

The eggspooner is an artificial lockable egg shell. It consists of a receptacle and a screw cap. Now you can prepare your breakfast egg as you like it. For instance you can prepare an egg with cream cheese and shredded salmon or an egg with cream cheese and caviar or an egg with basil or other spices or other ingredients—there are no limits for the imagination of the housewife or the cooking person!

The ingredients can be putted into the eggspooner and can be cooked now in a pot of water, just as a normal egg. (It just takes a little bit more of time.)

The screw cap of the eggspooner works as screw caps of commercial food packages. But the sealing compound at the inside of eggspooners screw cap is isolated by a layer of PTFE (FDA; Title 21 Code of Federal Regulations § 177.1550), so that the foods cannot be contaminated while cooking.

1. Eggspooner
distinguished by
the consist of a receptacle for the intake of an egg and additional ingredients and a screw cap with a by a layer of PTFE isolated sealing compound at its inside, to be closed waterproofed and to enable to cook an egg and additional ingredients in an artificial shell.

2. Eggspooner, going by claim 1,
distinguished by
the possibility to take in the contents of several eggs.

3. Eggspooner, going by one of the previous claims,
distinguished by
the enabling by its form to be putted down without falling down.
